(19) United States
(12) Patent Application Publication
(10) Pub. No.: US 2026/0089113 A1
(43) Pub. Date: Mar. 26, 2026

(54) LATENCY FEEDBACK FOR OPTIMIZING A THIRD-PARTY LINK

(71) Applicant: Ceragon Networks Ltd., Rosh HaAyin (IL)

(72) Inventors: Anton BEDINERMAN, Rosh HaAyin (IL); Yoav HEIMAN, Beit Horon (IL); Amir PERELSTAIN, Kfar-Saba (IL)

(73) Assignee: Ceragon Networks Ltd., Rosh HaAyin (IL)

(21) Appl. No.: 19/107,584

(22) PCT Filed: Aug. 21, 2023
(86) PCT No.: PCT/IL2023/050886

§ 371 Date: Feb. 28, 2025

Related U.S. Application Data
(60) Provisional application No. 63/401,728, filed on Aug. 29, 2022.

(51) Int. Cl. H04L 47/283; H04L 47/263

(52) U.S. Cl. CPC H04L 47/283; H04L 47/263

(57) ABSTRACT

A transmitter receives latency-feedback packets for determining a third-party-link ingress-memory utilization comprising: a memory for storing an Ethernet stream from the network; a processor configured to split an Ethernet stream from the memory into a plurality of frames, wherein the processor is configured to transfer the plurality of frames to at least one data-path. The processor executes a transmitter configured to (1) insert a time-stamp value into the plurality of frames; (2) transmit the plurality of frames via the at least one data-path; (3) increase the transmission capacity until detecting a first threshold via a latency-feedback packet to fill a third-party ingress-memory for an upper edge-scenario protection; (4) decrease the transmission capacity until detecting a second threshold via the latency-feedback packet to empty a third-party ingress-memory for the lower edge-scenarios protection; and (5) adjust the transmission capacity, raising and lowering capacity until reaching a hysteresis value for a latency-feedback value.

### RELATED APPLICATION/S

This application claims the benefit of priority of U.S. Provisional Ser. No. 63/401,728 filed on Aug. 29, 2022, the contents of which are incorporated herein by reference in their entirety.

### FIELD AND BACKGROUND OF THE INVENTION

The description relates to a system comprising a transmitter adapted to receive latency feedback packets for determining a third-party-link ingress-memory size from a receiver for performing dynamic changes in dividing communications for sending over one or more paths, and, more particularly, but not exclusively, to performing dynamic changes in dividing communications to optimize the throughput and reduce delay variation.

The disclosures of all references mentioned above and throughout the present specification, as well as the disclosures of all references mentioned in those references, are hereby incorporated herein by reference.

### SUMMARY OF THE INVENTION

The present disclosure, in some embodiments thereof, relates to performing dynamic communications and switching technologies. The present disclosure, in some embodiments thereof, relates to performing dynamic changes in dividing communications for sending over two or more paths, and, more particularly, but not exclusively, to performing dynamic changes in dividing communications for sending over a first bi-directional path which enables gathering data relating to communications sent over a second path.

A transmitter adapted to receive latency feedback packets for determining a third-party-link ingress-memory size comprising: a memory for storing an Ethernet stream sourced from the network; a processor configured to split an Ethernet stream from the memory into a plurality of frames, wherein the processor is configured to transfer the plurality of frames to at least one data path; and a media access port (MAC). The MAC transmits the plurality of frames via the at least one data path, wherein the at least one data path is a third-party-link. The processor is further adapted to execute a transmitter code configured to (1) insert a time-stamp value into the plurality of frames; (2) transmit the plurality of frames via the at least one data path; (3) increase the transmission capacity until detecting a first threshold via a latency feedback packet to fill a third party ingress-memory for an upper edge-scenario protection; (4) decrease the transmission capacity until detecting a second threshold via the latency feedback packet to empty a third party ingress-memory for the lower edge-scenarios protection; and (5) adjust the transmission capacity, raising and lowering capacity until reaching a hysteresis value for a latency feedback value.

In some aspects, the plurality of frames is having an equal-sized payload. In some aspects, the first threshold value is selected from a: (1) a user input value; (2) a value learned by the transmitter by detecting increases in the latency feedback value, and wherein the second threshold is value is selected from a (1) a user input value; and (2) a value learned by the transmitter by detecting decreases in the latency feedback value. In some aspects, the transmitter further comprises adaptive thresholds to optimize the throughput and reduce delay variation. In some aspects, the adaptive thresholds converges for optimal throughput of a third-party-link via a capacity tracking. In some aspects, the capacity tracking maximizes channel capacity packet throughput of the third-party-link while lessening packet delay. In some aspects, the capacity tracking narrows the adaptive thresholds to optimize the throughput and reduce delay variation until converging to a steady state. In some aspects, the capacity tracking is adapted to use a first order derivative to determine a third party ingress-memory capacity and a second order derivatives to determine the rate of latency feedback value changes and wherein filling the third party ingress-memory is indicated by a positive value for a first derivative operation on the latency feedback value. In some aspects, emptying the third party ingress-memory is indicated by a negative value for a first derivative operation on the latency feedback value. In some aspects, further comprising a Modem Sub-System for transmitting a second plurality of frames having a second equal-sized payload via a second data path.

A receiver providing latency feedback packets to a transmitter for determining a third-party-link ingress-memory size comprises: a media access port (MAC) for receiving a plurality of plurality of frames via at least one data path, wherein the at least one data path is a third-party-link; a memory to receive a plurality of frames from the MAC; and a processor. The processor is adapted to execute a receiver processor code to (1) store the plurality of frames to the memory; (2) extract and save a time-stamp value for each of the plurality of frames for determining a time of transmission and to calculate the latency feedback value as the difference between the time stamp value at the time of transmission and the time-stamp value at the time of receiving; (3) send the latency feedback value via a latency feedback packets to the transmitter to sense a third-party-link memory filling and emptying. In some aspects, receiver comprises a Modem Sub-System for receiving a second plurality of frames having a second equal-sized payload via a second data path from a transmitter. In some aspects, the second data path from the receiver to the transmitter is configured for sending latency feedback packets. In some aspects, wherein, sending latency feedback packets the at least one data from the receiver to the transmitter for providing latency feedback packets is via the third-party-link. In some aspects, the receiver further comprises receiver time-stamp counters phase aligned, frequency aligned, and synchronized to transmit a time-stamp value for each of the plurality of frames to the transmitter according to the IEEE-1588 standard.

A computer implemented method is implemented to determine a third-party ingress-memory size. The method comprising a plurality of steps to: store an Ethernet stream sourced from the network into a transmitter memory and split the Ethernet stream from the transmitter memory into a plurality of frames; insert a time-stamp value into the plurality of frames; transmit the plurality of frames having a via at least one data path, wherein the at least one data path is via a third-party-link; receives latency feedback packets for determining a third party ingress-memory size, wherein the transmitter receives the latency feedback packets and a receiver sends the latency feedback packets. The method can increase the capacity until detecting a first threshold via a latency feedback packet for filling a third party ingress-memory, wherein filling a third party ingress-memory detects the first threshold for an upper edge-scenario protection and prevents packet loss and can lower the capacity until detecting a second threshold via the latency feedback packet, wherein emptying the third party ingress-memory detects the a second threshold for a lower edge-scenarios protection; and adjust the capacity during transmission, raising and lowering the equal-sized payload size until reaching a hysteresis value for a latency feedback value to optimize a channel capacity and lessen packet delay variation.

In some aspects, the receiver: stores the plurality of frames to a receiver memory; extracts and saving a time-stamp value for each of the plurality of frames for determining a time of transmission; determines the latency feedback value as the difference between the time stamp value at the time of transmission and the time-stamp value at the time of receiving; and sends the latency feedback value via the latency feedback packets to the transmitter to for sensing the third-party-link memory filling and emptying, wherein latency feedback packets provide an indication for determining optimal capacity for transmission. In some aspects, determining a third-party ingress-memory size using a first set of hysteresis thresholds for an upper and a lower edge protections, wherein the first threshold indicates a full ingress-memory with a high latency and wherein the transmitter receives a Pause packet causing a decrease in transmission capacity until the second threshold indicates a low latency with underutilization to cause an increase in transmission capacity. In some aspects, determining a third-party ingress-memory size uses a second set of set of adaptive thresholds for a convergence of transmission capacity. In some aspects, the second set of set of adaptive thresholds for convergence is using a first order and a second order derivative operations on the latency feedback value to determine the hysteresis value, wherein convergence determines the hysteresis value for a steady state transmission.

Unless otherwise defined, all technical and/or scientific terms used herein have the same meaning as commonly understood by one of ordinary skill in the art to which the disclosure pertains. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present disclosure may be embodied as a system, method or computer program product. Accordingly, some embodiments of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present disclosure may take the form of a computer program product embodied in one or more computer readable medium(s) having computer readable program code embodied thereon. Implementation of the method and/or system of some embodiments of the disclosure can involve performing and/or completing selected tasks manually, automatically, or a combination thereof. Moreover, according to actual instrumentation and equipment of some embodiments of the method and/or system of the disclosure, several selected tasks could be implemented by hardware, by software or by firmware and/or by a combination thereof, e.g., using an operating system.

For example, hardware for performing selected tasks according to some embodiments of the disclosure could be implemented as a chip or a circuit. As software, selected tasks according to some embodiments of the disclosure could be implemented as a plurality of software instructions being executed by a computer using any suitable operating system. In an exemplary embodiment of the disclosure, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the disclosure. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present disclosure may be described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### BRIEF DESCRIPTION OF THE SEVERAL VIEWS OF THE DRAWING(S)

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings.

FIG. 1 is a high-level block diagram illustrating a dynamic system having latency feedback for reducing pauses and optimizing the utilization of a third-party link ingress-memory, according to some embodiments of the present invention;

FIG. 2 is a second block diagram further illustrating a dynamic system having latency feedback for utilizing the third-party link ingress-memory, according to some embodiments of the present invention;

FIG. 3 is a block diagram further illustrating the elements of the dynamic system transceiver, according to some embodiments of the present invention;

FIG. 4 is a block diagram illustrating latency feedback packets, according to some embodiments of the present invention;

FIG. 5A is a block diagram illustrating radio framing, according to some embodiments of the present invention;

FIG. 5B is a diagram illustrating an Ethernet stream received from the network, according to some embodiments of the present invention;

FIG. 5C is a diagram illustrating a generic frame, according to some embodiments of the present invention;

FIG. 5D is a diagram illustrating a radio frame structure, according to some embodiments of the present invention;

FIG. 6A is an example diagram illustrates radio framing a jumbo packet, according to some embodiments of the present invention;

FIG. 6B is an example diagram illustrating a generic frame for splitting into a radio frame, according to some embodiments of the present invention;

FIG. 6C is an example diagram illustrating a radio frame structure, according to some embodiments of the present invention;

FIG. 7 is a diagram illustrating Reordering for Ethernet frame Generation, according to some embodiments of the present invention; and

FIG. 8 is an XY Frame graph illustrating latency feedback thresholds, according to some embodiments of the present invention.

FIG. 9 is a flowchart of a method for determining a third party ingress-memory size.

### DESCRIPTION OF SPECIFIC EMBODIMENTS OF THE INVENTION

The present disclosure, in some embodiments thereof, relates to performing dynamic changes in dividing communications for sending over two or more paths, and, more particularly, but not exclusively, to performing dynamic changes in dividing communications for sending over a first bi-directional path which enables gathering data relating to communications sent over a second path.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

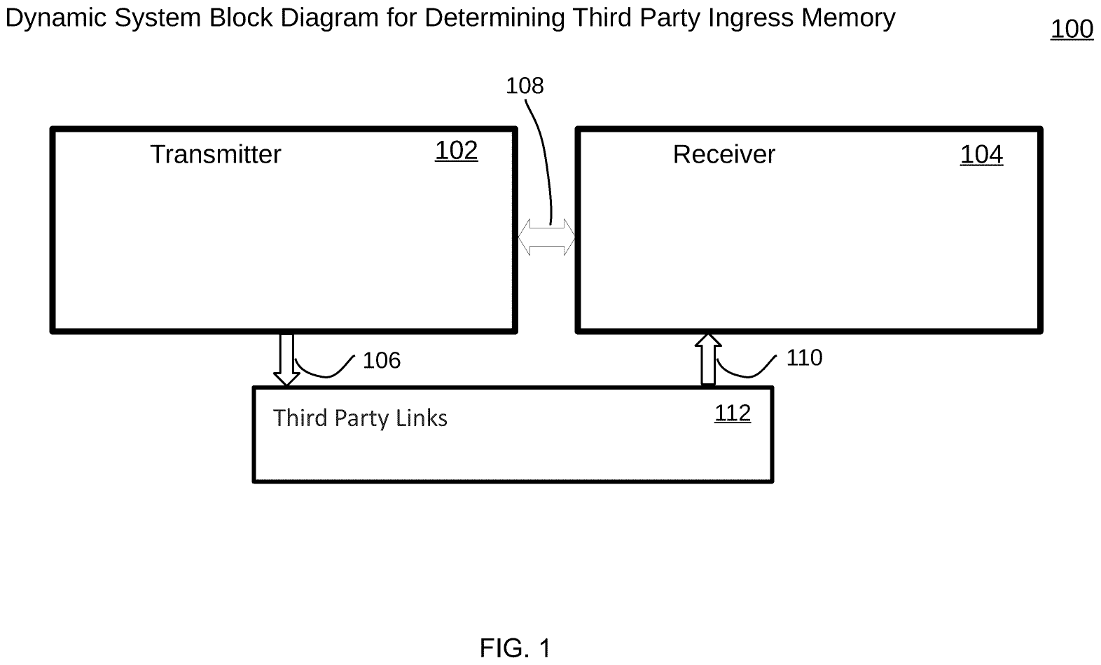

Referring now to FIG. 1, high level block diagram illustrating a dynamic system having latency feedback for reducing pauses and optimizing the utilization of a third-party ingress-memory. System 100 shows a transmitter 102 configured to transmit data comprising a plurality of frames having an equal-sized payload to at least two links for a plurality of frames having an equal-sized payload. Data is transmitted via at least one data path 106 to at least one third-party link 112, which in turn transmits the data to a receiver 104 via bus 110. In some aspects, the data can be an Ethernet stream, In some aspects, the data is a datagram. The transmitter block 102 transmits data via a second data path 108 to the receiver 104. In some aspects, the second data path 108 can provide a path for the latency feedback using a latency feedback data packet to provide information to the transmitter regarding the third-party link ingress-memory size. In some aspects, the data path 106 can provide a path for the latency feedback using a latency feedback data packet.

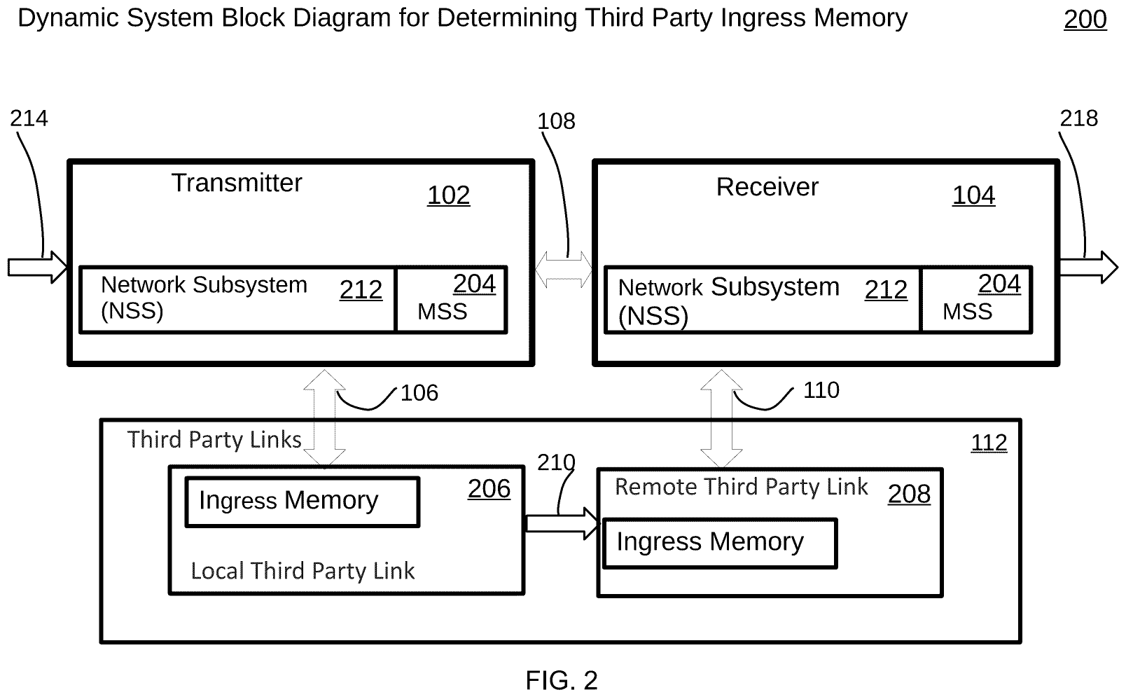

Referring now also to FIG. 2, a second block diagram is further illustrating high level block diagram illustrating a dynamic system having latency feedback for utilizing the third-party ingress-memory. System 200 comprises the blocks 102, 104, and block 112 is further comprising blocks 206 and 208. Block 102 is a local transmitter and block 104 is a remote receiver in this example. Blocks 102 and 104 are transceivers for both transmitting and receiving data. The blocks 102 and 104 are identical modules, where both blocks 102 and 104 are further comprising the structure of a Network Sub-System (NSS) block 212 and the Modem Sub-System (MSS) block 204. In some aspects, the Modem Sub-System 212 can include a bank of modems comprising a plurality of frequencies. In some aspects, the MSS 212 is at least one MSS and can include a plurality of MSS. At least one bi-directional link 108 connects the local transmitter 102 to the remote receiver 104. In some aspects, there is a modem or radio and not necessarily a Modem Sub-System. The third-party links in block 112 comprises two third-party blocks 206 and 208. In some aspects there are at least one third-party link. There can be two or more third-party links. Block 206 is connected to the transmitter 102 via at least one data path 106. Third-party links 112 transmits the data from the transmitter 102 to the receiver 104 via bus 110 to complete at least one data path. The blocks 206 and 208 are interconnected via 210 for wireless transmission. Bus 214 is an input port from a network and bus 218 is an output to a network. In some aspects, the network provides an Ethernet stream comprising a plurality of Ethernet packets.

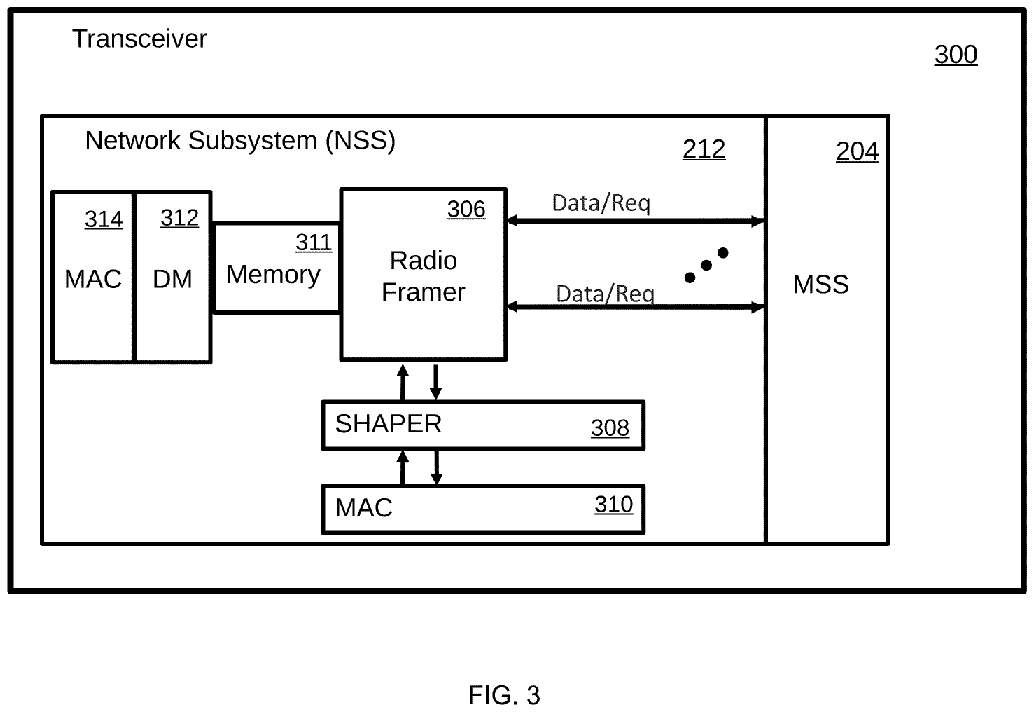

Referring now also to FIG. 3, a block diagram is further illustrating the elements of a dynamic transceiver module. Block 300 show a Network Sub-System (NSS) 212 and the Modem Sub-System (MSS) 204. The NSS 212 is comprising: a first media access controller (MAC) 310 that connects to at least one data path; a second media access controller (MAC) 314 connected to the network; a Data Manager (DM) 312 connecting to the second MAC 314; a memory 311 connecting to the DM 312. In some aspects the radio framer 306 connects to the memory 311, wherein the radio framer 306 is configured to split an Ethernet stream into a plurality of frames having an equal-sized payload. The radio framer 306 connects to the at least one data path and connects to the second data path. In some aspects, the second data path is comprising a data and request line. In some aspects, the second data path is comprising a separate data line and a separate request line. In some aspects, the second data path can comprise one or more data and request links. In some aspects, the second data path is bi-directional. In some aspects, each of the second data paths corresponds to a Modem/Radio carriers/link. A shaper circuit 308 is connecting between the radio framer 306 and the first MAC 310. The shaper circuit can limit the traffic rate and traffic bursts of datagrams. The shaper circuit can provide traffic shaping for data as a bandwidth management technique for computer networks. In some aspects, the resolution is a discrete number. In some aspects the shaper is updated by the NSS responding to a Bandwidth Notification Message (BNM) or a pause packet. The BNM is defined by ITU G.8013/Y.1731 In one aspect, the NSS can couple to MSS 204 for a second data path.

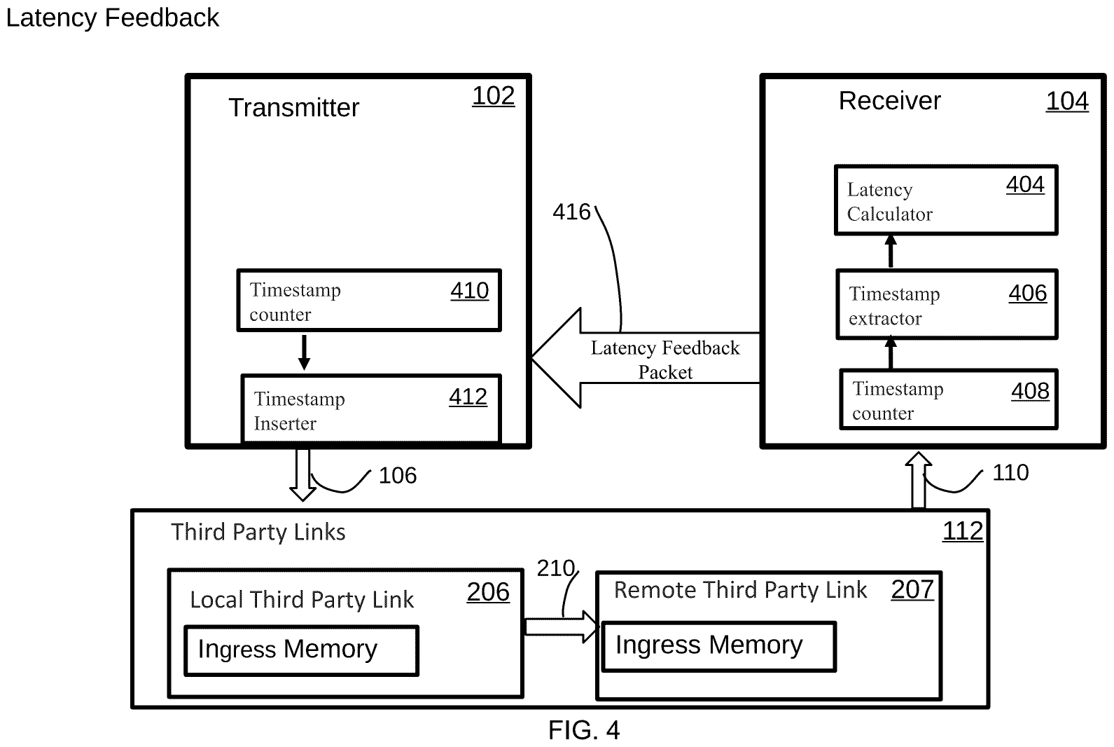

Referring now also to FIG. 4, a block diagram illustrates latency feedback packets. System 400 comprises three blocks: (1) a transmitter block 102; (2) the receiver block 104, and (3) the third-party Links 112 which was described above. The transmitter block 102 receives as an input the latency feedback packet 416 which is sent from the receiver side block 104. Block 102 further comprises a timestamp counter circuit 410 and times stamp inserter circuit 412. In some aspects, a time-stamping circuit connects between the radio framer 306 and the first MAC circuit. In some aspects the time-stamping circuit is embedded in the radio framer 306.

In some aspects, the transmitter block 102 has a time-stamp circuit configured to insert a time-stamp value into a plurality of frames having an equal-sized payload. In some aspects, a function in a processor is configured to insert a time-stamp value into a plurality of frames having an equal-sized payload.

According to some aspects, the receiver block 104 further comprises the following circuits: Time-stamp counter 408, time-stamp extractor circuit 406, and latency calculator 404. According to some aspects, the receiver block 104 further comprises a processor to execute a code (1) to save the Time-stamp counter circuit 408 value for an arriving frame; (2) to execute a time-stamp extractor 406 function from the frame that arrived 406, and a latency calculator 404 to sum the difference between the values of 406 and 410 to determine the latency value. The local and receiver time-stamp counters are phase and frequency aligned according to the IEEE 1588 standard. In some aspects, the local and receiver time-stamp counters circuits 408 are phase aligned, frequency aligned, and synchronized to transmit a time-stamp value using a time stamp extractor circuit 406 and latency calculator circuit 404 for each of the plurality of packets to the according to the IEEE-1588 standard.

The receiver block 104 is configured to extract a time-stamp from the plurality of frames having an equal-sized payload, calculate the value and send it to the transmitter block 102.

A latency feedback packet 416 is generated after the latency calculation and it sent via the second data path from block 104 to block 102. The latency feedback packet will instruct the transmitter 102 to update the shaper. The transmission latency value of at least one data path is provided as an input value via the second data path.

In some aspects, the latency feedback packet can provide information regarding the status of a third-party link ingress-memory where the 3rd party link acts as Pipe Mode device. In Pipe Mode, a third-party network device 112 can use the following modes: BNM packets mode, Pause packets mode, or operate without any flow control support for Ethernet streams or datagrams.

Pipe Mode operations may operate with (1) no quality of service (QOS); (2) no smart dropping mechanism; (3) no port policing or shaping; (4) difficulty maintaining flexible ingress-memory (queue/FIFO) size; (5) pause packet mode; and (6) BNM packet. In some aspects, the transmitter corrects: (1) high latency and delay variation of the third-party link operating in pause mode; and (2) traffic loss of the third-party link operating in BNM mode.

BNM mode are: (1) not supported by all vendors; (2) response time differs between vendors and is not deterministic; (3) some vendors assert BNM packet after the BW already changed.

Pause mode is: (1) not supported by all vendors; (2) flexible thresholds are not always supported; ingress-memory (queue/FIFO) size is not always transparent to user; and (3) can cause high latency and delay variation.

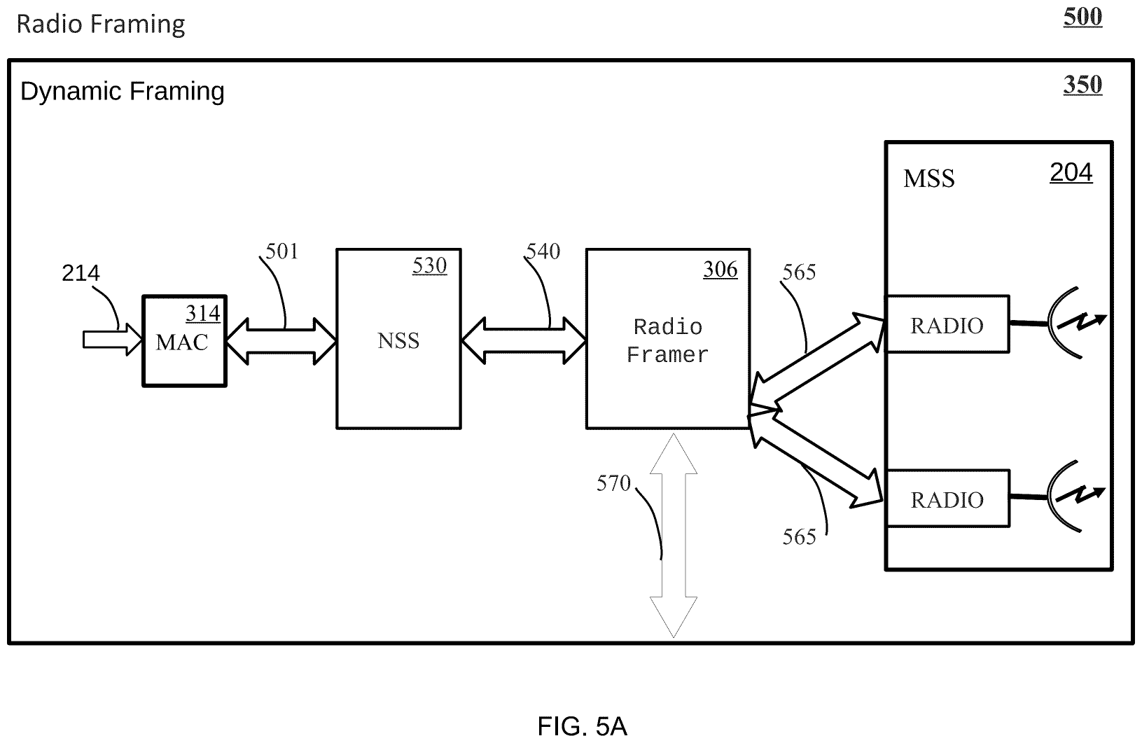

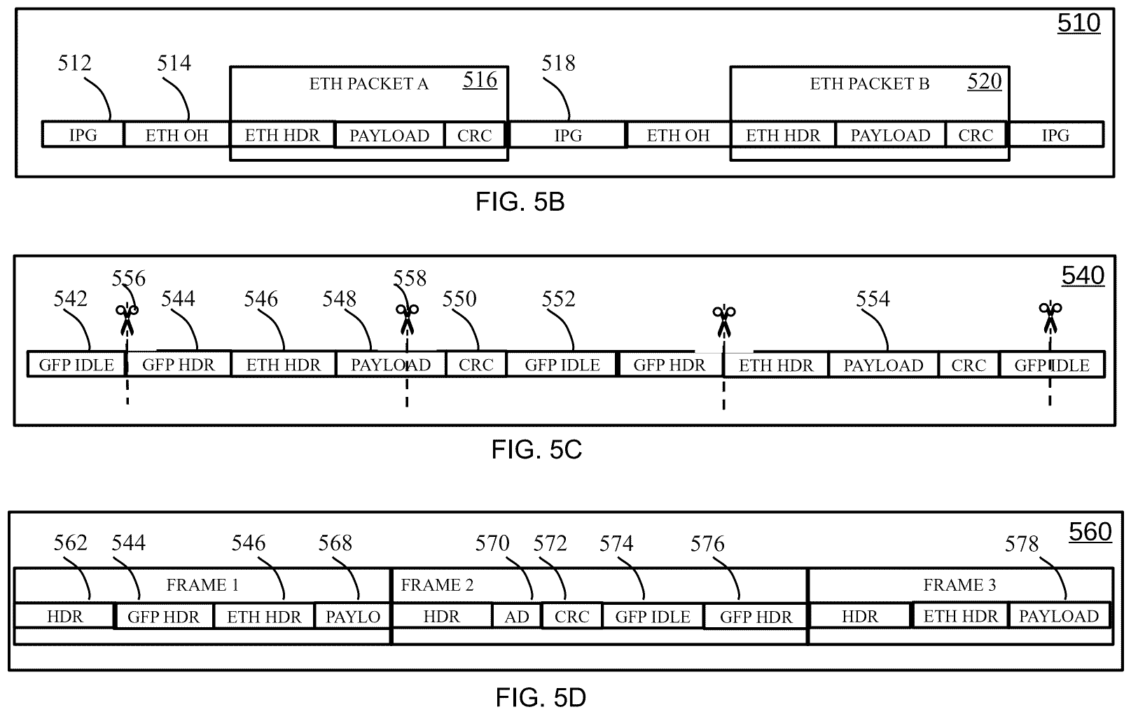

Referring now also to FIG. 5A, a high-level block radio framing diagram 500 is shown illustrating the path and components in a framing sequence for parsing an Ethernet stream from the network. In some aspects, a Dynamic Framing block 350 further comprises the blocks: (1) MAC 314 for connecting to the network; (2) Network Sub-System (NSS) block 530 configured to receive and transmit Ethernet packets to/from the network; (5) radio framer 306; and (6) buses 565 and 570 have the frame structure described below in FIG. 5D.

The MAC 314 connects to the network via input port 214 and to the NSS block 530 via bus 501. NSS block 530 connects to the radio framer 306 via bus 540. Radio framer 306 connects to the MSS 204 via buses 565, which are described above as the second data path. The radio framer 306 interfaces via the at least one path 570, which is at least one third-party link. In some aspects, the radio framer is a radio bonder for frames sent to specific radios for the purpose of load balancing.

Referring now also to FIG. 5B, a diagram illustrating Ethernet packets and frames. The Ethernet packet 510 is the input to the ESS block shows a number of fields, where the field 512 IPG is an Inter-packet Gap and the field 514 ETH OH is Ethernet Overhead. In some aspects, the ETH OH provides a preamble to a network processor. The block 516 show the contents of an Ethernet packet A consisting of an Ethernet Header (ETH HDR); payload; and a cyclical redundancy checker (CRC).

Referring now also to FIG. 5C, shows a diagram illustrating and NSS block 530 splitting an Ethernet Frame into a plurality of generic frames having an equal-sized payload. The fields are 542 (GFP)-Generic Framing Procedure; a scissor icon 556 to split a frame for radio framing; field 544 GFP HDR is the Generic Framing Procedure header; 546 is the Ethernet Header (ETH HDR); 548 is the payload which is cut in this example; and 550 is the CRC.

Referring now also to FIG. 5D, a diagram illustrating a radio frame structure. The first field, HDR 562 is the header and consists of 4 bytes. The second field 544 GFP HDR and 546 ETH HDR are described supra in FIG. 5C. Fields 568 shows the first part of the payload 548 of FIG. 5C in Frame 1 and the second half of the payload 548 of FIG. 5C in the Frame 2 as 570 “AD”. The Frame 3 receives the entire payload 554 in this example as there was no split performed. The radio frame can be referred to as a frame, as was done for the claims.

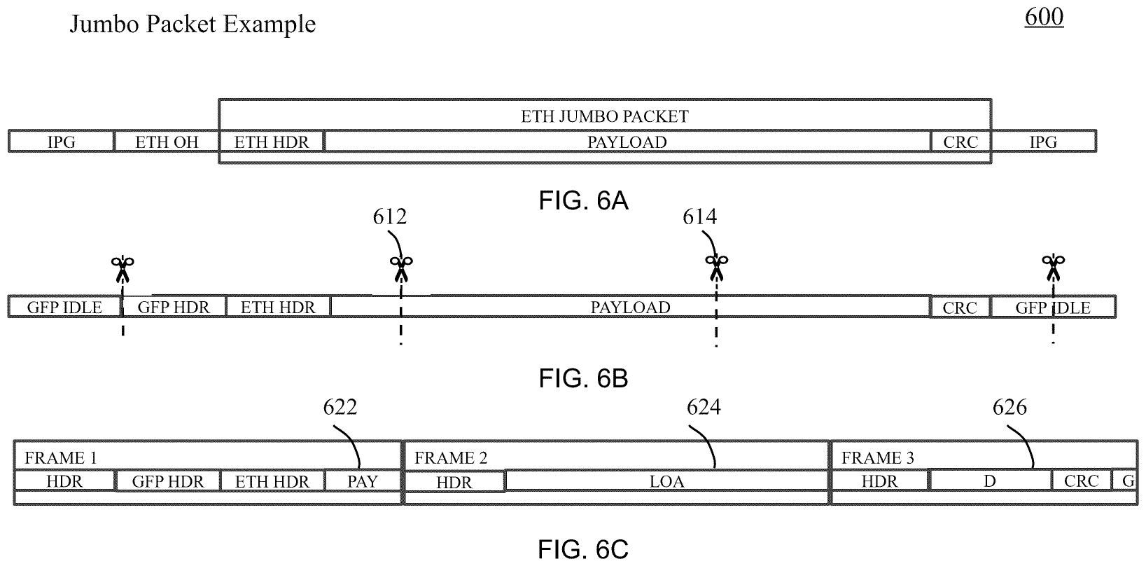

Referring now to an example diagram illustrating framing of a Jumbo Packet. Diagram 600 shows three figures, FIGS. 6A, 6B, and 6C. Referring supra to FIGS. 5A-5D, the fields were previously described. This example illustrates a first jumbo packet in an Ethernet Frame shown in FIG. 6A. It is split in FIG. 6B into three payloads by the icon scissors 612 and 614. FIG. 6C shows the frame with the first payload “PAY” 622 in frame 1, the second payload “LOA” 624 in frame 2, and the third payload “D” 626 in frame 3. In some aspects, to keep equal-sized payloads data-packing can be used.

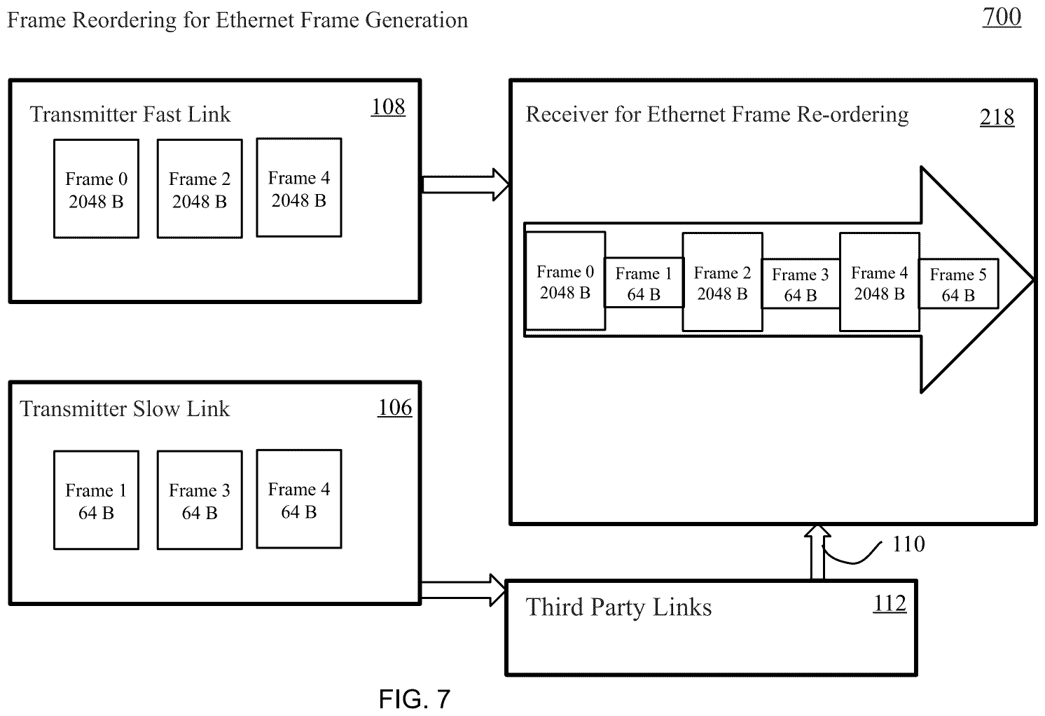

Referring now also to FIG. 7, a diagram is shown illustrating Frame Reordering for Ethernet Frame Generation. System 700 comprises the three interfaces, Transmitter Fast Link 108 with frames carrying 2048 bytes each, Transmitter Slow Link 106 with frames carrying 64 bytes each interfacing to the third-party Links block 112 driving 110. These interfaces were described above in FIG. 2. It is important to note, and show visually, that although the plurality of frames having an equal-sized payload have equal-sized payloads, the payloads are only equal for each data path. Therefore a first plurality of a plurality of frames having an equal-sized payload and a second plurality of a plurality of frames having an equal-sized payload do not require the same payload sizes.

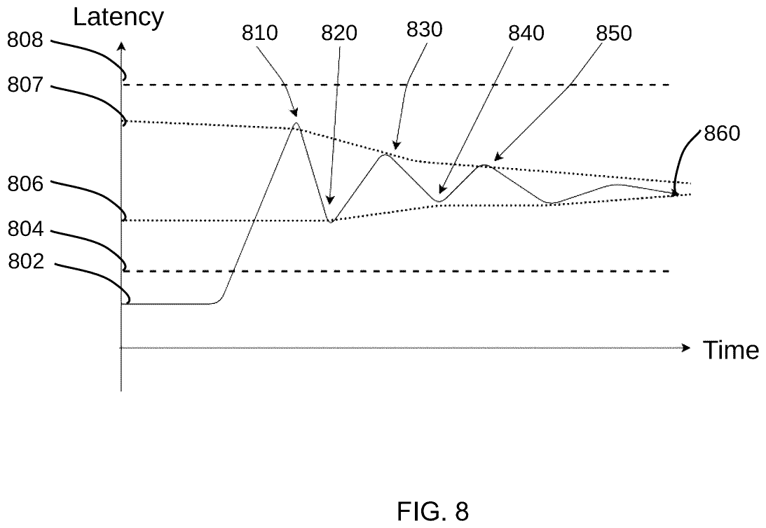

Referring now to FIG. 8, a graph diagram is shown illustrating latency capacity and feedback thresholds having a direct connection between the latency capacity and the throughput transmitted via the 3rd party link. A graph is illustrated with a Y-axis representing the latency of packets across a network. The X-axis is labeled time and the graph shows the capacity 802 and latency over time. A first threshold 808 represents the high threshold of the first set. In some aspects, the transmission capacity increases until detecting a first threshold via a latency feedback packet to fill a third-party ingress-memory for an upper edge-scenario protection. In some aspects, the first threshold value is selected from a: (1) a user input value; and (2) a value learned by the transmitter by detecting increases in the latency feedback value. In some aspects, the first threshold value is detected by a Pause packet. A second threshold 804 represents the least amount of latency for a third-party link where the ingress-memory of will remain substantially empty. In some aspects, the transmitter lowers the equal-sized payload size until detecting a second threshold via the latency feedback packet to empty a third-party ingress-memory for the lower edge-scenarios protection. In some aspects, the second threshold 804 is a value selected from a (1) a user input value and (2) a value learned by the transmitter by detecting decreases in the latency feedback value.

In some aspects, the capacity tracking is accomplished by at least one processor configured to execute first order derivative instructions to determine a third-party ingress-memory status and for the at least one processor to execute a second order derivative instructions to determine the rate of latency feedback value changes, wherein filling the third-party ingress-memory is indicated by a positive value for a first derivative operation on the latency feedback values.

At least one processor can execute instructions to determine adaptive thresholds to optimize the throughput and to reduce delay variation. The delay variation is defined as no more than 20% of the nominal delay. An optimal utilization of a single TCP Ethernet stream for a third-party link utilization is greater than 85%; the optimal utilization for multiple Ethernet streams is 99%. The first adaptive threshold 807 represents the upper limit of latency. The second adaptive threshold 806 represents the lower limit of latency. An example adaptive threshold 810 indicates a limit to begin reducing the channel capacity via the third-party link until the first lower adaptive threshold 820 indicates a limit to begin increasing capacity. This process repeats with the at least one processor executing instructions to determine a second upper adaptive threshold 830 (an adaptive threshold lower than 810), to begin reducing the channel capacity until a second lower adaptive threshold 840 (greater latency than 820). The new lower limit of 840 is an indication to begin increasing capacity and with it increasing latency. The latency continues to rise until a third adaptive threshold 850, wherein this process continues until a convergence at a steady state 860. The latency will approach a steady state having a maximum hysteresis value of twice the order of the resolution for setting the shaper. The adaptive thresholds converge at example 860 after a plurality of iterations for optimal capacity (throughput) of a third-party-link via a capacity tracking.

In some aspects, the capacity tracking maximizes utilization of the third-party-link while lessening packet delay. In some aspects, the capacity tracking narrows the adaptive thresholds to optimize the throughput and reduce delay variation until reaching a steady state. In some aspects, the capacity tracking is adapted to use a first order derivative to determine a third-party ingress-memory capacity and a second order derivatives to determine the rate of latency feedback value changes. In some aspects, filling the third-party ingress-memory is indicated by a positive value for a first derivative operation on the latency feedback values. In some aspects, emptying the third-party ingress-memory is indicated by a negative value for a first derivative operation on the latency feedback values. A computer implemented method for determining a third-party ingress-memory size can comprise: storing a plurality of Ethernet packets encapsulated in an Ethernet stream sourced from the network into a transmitter memory; splitting the Ethernet stream from the memory from the transmitter memory into a plurality of frames having an equal-sized payload; inserting a time-stamp value into plurality of frames; transmitting the plurality of frames having a via a at least one data path, wherein the at least one data path is via a third-party-link; transmitting the second plurality of packets having a second-equal-sized payload via a second data path, wherein the second data path is via a Modem Sub-System (MSS); receiving latency feedback packets for determining a third-party ingress-memory utilization or a third-party ingress-memory usage, wherein the transmitter receives the latency feedback packets and a receiver sends the latency feedback packets; increasing the transmission capacity until detecting a first threshold via a latency feedback packet for filling a third-party ingress-memory, wherein filling a third-party ingress-memory detects the first threshold for an upper edge-scenario protection and prevents packet loss; lowering the transmission capacity until detecting a second threshold via the latency feedback packet, wherein emptying the third-party ingress-memory detects the a second threshold for a lower edge-scenarios protection; and adjusting the transmission capacity, raising and lowering the equal-sized payload size until reaching a hysteresis value for a latency feedback value to optimize a channel capacity and lessen packet delay variation. In some aspects, the receiver stores the first and the second plurality of packets having an equal-sized payload to a receiver memory; extracts and saves a time-stamp value for each of the plurality of packets for determining a time of transmission; determines the latency feedback value as the difference between the time stamp value at the time of transmission and the time-stamp value at the time of receiving; and sends the latency feedback value via the latency feedback packets to the transmitter to for sensing the third-party-link memory filling and emptying, wherein latency feedback packets provide an indication for determining optimal capacity for transmission.

In some aspects, determination of a third-party ingress-memory utilization uses a first set of hysteresis thresholds for an upper and a lower edge protections, wherein the first threshold indicates a high latency and transmission throughput is lowered and the second threshold indicates a low latency and transmission throughput is raised. In some aspects, determining a third-party ingress-memory utilization uses a second set of set of adaptive thresholds for convergence of payload packet capacity for transmission. In some aspects, the second set of adaptive thresholds for convergence is using a first order and a second order derivative operations on the latency feedback values to determine the hysteresis value, wherein convergence determines the hysteresis value for a steady state transmission.

In some aspects, at least one processor is adapted to execute a transmitter code configured to (1) ) insert a time-stamp value into the first and the second plurality of packets having the first and the second equal-sized payload packet; (2) transmit the first and the second plurality of packets having an equal-sized payloads via the at least one data path and via the second data path; (3) increase an equal-sized payload size until detecting a first threshold via a latency feedback packet to fill a third-party ingress-memory for an upper edge-scenario protection; (4) lower the equal-sized payload size until detecting a second threshold via the latency feedback packet to empty a third-party ingress-memory for the lower edge-scenarios protection; and (5) adjust the equal-sized payload size transmission, raising and lowering until reaching a hysteresis value for a latency feedback value.

In some aspects, a receiver 104 provides latency feedback packets to a transmitter 102 for determining a third-party-link ingress-memory utilization comprising: a media access port (MAC) for receiving a plurality of frames having an equal-sized payload via at least one data path, wherein the at least one data path is a third-party-link; a first memory to receive a plurality of frames having an equal-sized payload from the MAC, wherein a processor adapted to execute a receiver processor code to (1) store the first and second plurality of packets having an equal-sized payload to a memory; (2) extract and save a time-stamp value for each of the plurality of packets for determining a time of transmission and to calculate the latency feedback value as the difference between the time stamp value at the time of transmission and the time-stamp value at the time of receiving; (3) send the latency feedback value via a latency feedback packets to the transmitter to sense a third-party-link memory filling and memory emptying. In some aspects, the receiver 104 is further comprising a data path from the receiver to the transmitter for providing latency feedback packets. In some aspects, the receiver further comprises a modem Sub-System (MSS) for receiving a second plurality of packets having an equal-sized payload via a second data path via a transmitter and a second memory to receive a second plurality of packets having an equal-sized payload from the MSS. In some aspects, the data path from the receiver to the transmitter for providing latency feedback packets is via the at least one data path 106 when the second data path is not available.

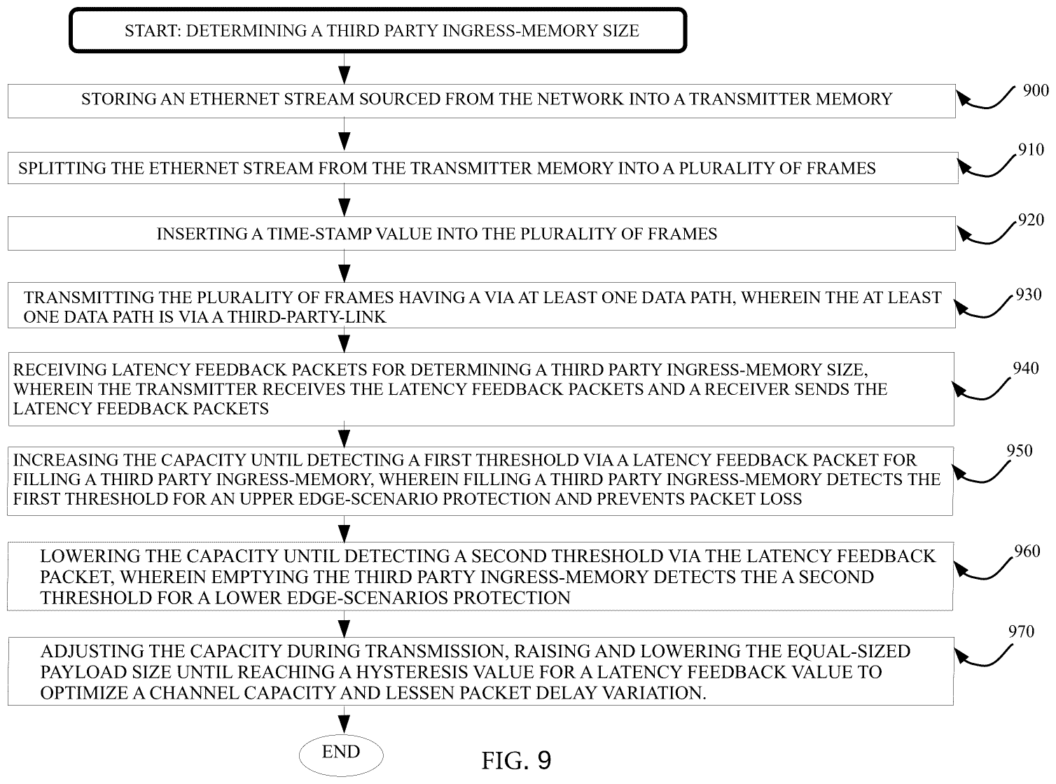

Referring now to FIG. 9, a flowchart shows the steps of a method for a computer implemented method for determining a third party ingress-memory size, the method comprising the following steps. At step 900, store an Ethernet stream sourced from the network into a transmitter memory. At step 910, split the Ethernet stream from the transmitter memory into a plurality of frames. At step 920, insert a time-stamp value into the plurality of frames. At step 930, transmit the plurality of frames having a via at least one data path, wherein the at least one data path is via a third-party-link. At step 940, receive latency feedback packets for determining a third party ingress-memory size, wherein the transmitter receives the latency feedback packets and a receiver sends the latency feedback packets. At step 950, increase the capacity until detecting a first threshold via a latency feedback packet for filling a third party ingress-memory, wherein filling a third party ingress-memory detects the first threshold for an upper edge-scenario protection and prevents packet loss. At step 960, lower the capacity until detecting a second threshold via the latency feedback packet, wherein emptying the third party ingress-memory detects the a second threshold for a lower edge-scenarios protection, and At step 970, adjust the capacity during transmission, raising and lowering the equal-sized payload size until reaching a hysteresis value for a latency feedback value to optimize a channel capacity and lessen packet delay variation.

It is expected that during the life of a patent maturing from this application many relevant data points for latency will be developed and the scope of the term load balancing is intended to include all such new technologies a priori.

As used herein with reference to quantity or value, the term “about” means “within ±10% of”.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Throughout this application, various embodiments of this disclosure may be presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers there between.

Unless otherwise indicated, numbers used herein and any number ranges based thereon are approximations within the accuracy of reasonable measurement and rounding errors as understood by persons skilled in the art.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A transmitter adapted to receive latency feedback packets for determining a third-party-link ingress-memory size comprising:
a memory for storing an Ethernet stream sourced from the network;
a processor configured to split the Ethernet stream from the memory into a plurality of frames, wherein the processor is configured to transfer the plurality of frames to at least one data path;
a media access port (MAC) for transmitting the plurality of frames via the at least one data path, wherein the at least one data path is a third-party-link; and
wherein the processor is adapted to execute a transmitter code configured to (1) insert a time-stamp value into the plurality of frames; (2) transmit the plurality of frames via the at least one data path; (3) increase the transmission capacity until detecting a first threshold via a latency feedback packet to fill a third party ingress-memory for an upper edge-scenario protection; (4) decrease the transmission capacity until detecting a second threshold via the latency feedback packet to empty a third party ingress-memory for the lower edge-scenarios protection; and (5) adjust the transmission capacity, raising and lowering capacity until reaching a hysteresis value for a latency feedback value;
wherein the processor is further configured to calculate determine at least one of a third-party ingress memory capacity and a rate of change of the latency feedback value based on one or more derivatives of the latency feedback value.

2. The transmitter of claim 1, and wherein the plurality of frames is having an equal-sized payload.

3. The transmitter of claim 1, wherein the first threshold value is selected from a: (1) a user input value; (2) a value learned by the transmitter by detecting increases in the latency feedback value, and wherein the second threshold is value is selected from a (1) a user input value; and (2) a value learned by the transmitter by detecting decreases in the latency feedback value.

4. The transmitter of claim 1, further comprising adaptive thresholds to optimize the throughput and reduce delay variation.

5. The transmitter of claim 4, wherein the adaptive thresholds converges for optimal throughput of a third-party-link via a capacity tracking.

6. The transmitter of claim 5, wherein the capacity tracking maximizes channel capacity packet throughput of the third-party-link while lessening packet delay.

7. The transmitter of claim 6, wherein the capacity tracking narrows the adaptive thresholds to optimize the throughput and reduce delay variation until converging to a steady state.

8. The transmitter of claim 7, wherein the capacity tracking is adapted to use a first order derivative to determine a third party ingress-memory capacity and a second order derivatives to determine the rate of latency feedback value changes and wherein filling the third party ingress-memory is indicated by a positive value for a first derivative operation on the latency feedback value.

9. The transmitter of claim 8, wherein emptying the third party ingress-memory is indicated by a negative value for a first derivative operation on the latency feedback value.

10. The transmitter of claim 1, further comprising a Modem Sub-System for transmitting a second plurality of frames having a second equal-sized payload via a second data path.

11. A receiver providing latency feedback packets to a transmitter for determining a third-party-link ingress-memory size comprising:
a media access port (MAC) for receiving a plurality of plurality of frames via at least one data path, wherein the at least one data path is a third-party-link;
a memory to receive a plurality of frames from the MAC; and
a processor adapted to execute a receiver processor code to (1) store the plurality of frames to the memory; (2) extract and save a time-stamp value for each of the plurality of frames for determining a time of transmission and to calculate the latency feedback value as the difference between the time stamp value at the time of transmission and the time-stamp value at the time of receiving; (3) send the latency feedback value via a latency feedback packets to the transmitter to sense a third-party-link memory filling and emptying; (4) calculate a rate of change of the latency feedback value to determine a rate of change of the latency feedback value.

12. The receiver of claim 11, further comprising a Modem Sub-System for receiving a second plurality of frames having a second equal-sized payload via a second data path from a transmitter.

13. The receiver of claim 12, further comprising the second data path from the receiver to the transmitter is configured for sending latency feedback packets.

14. The receiver of claim 13, wherein, sending latency feedback packets the at least one data from the receiver to the transmitter for providing latency feedback packets is via the third-party-link.

15. The receiver of claim 11, further comprising receiver time-stamp counters are phase aligned, frequency aligned, and synchronized to transmit a time-stamp value for each of the plurality of frames to the transmitter according to the IEEE-1588 standard.

16-20. (canceled)
